(19) United States
(12) Patent Application Publication
(10) Pub. No.: US 2012/0238451 A1
(43) Pub. Date: Sep. 20, 2012

(54) HERBICIDE AND ADJUVANT COMPOSITIONS AND METHOD OF USE THEREOF

(75) Inventors: Paul Feng, Wildwood, MO (US); Ronald Brinker, Ellisville, MO (US); William Duncan, St. Louis, MO (US); Alejandro Perez-Jones, St. Charles, MO (US)

(73) Assignee: MONSANTO TECHNOLOGY LLC, St. Louis, MO (US)

(21) Appl. No.: 13/422,444

(22) Filed: Mar. 16, 2012

Related U.S. Application Data
(60) Provisional application No. 61/453,574, filed on Mar. 17, 2011.

(51) Int. Cl. A01N 37/10; A01P 13/00

(52) U.S. Cl. 504/324

(57) ABSTRACT

The invention provides methods and herbicide compositions for weed control. The invention provides for enhancement of herbicide activity by the addition of an adjuvant. The herbicide activity is especially useful as a preplant and postplant treatment.

### REFERENCE TO RELATED APPLICATIONS

This application claims the benefit of U.S. provisional application Ser. No. 61/453,574, filed Mar. 17, 2011, the entire disclosure of which is incorporated herein by reference.

### FIELD OF THE INVENTION

The invention is directed to agricultural composition comprising auxin-like herbicides and ACCase inhibitors, and methods of use thereof, for example in the control of weeds in fields.

### BACKGROUND

Weeds cost farmers billions of dollars annually in crop losses and the expense of efforts to keep weeds under control. Weed control is the most important issue in agricultural production. Weeds also serve as hosts for crop diseases and insect pests. The losses caused by weeds in agricultural production environments include decreases in crop yield, reduced crop quality, increased irrigation costs, increased harvesting costs, reduced land value, injury to livestock, and crop damage from insects and diseases harbored by the weeds. The principal means by which weeds cause these effects are: 1) competing with crop plants for water, nutrients, sunlight and other essentials for growth and development, 2) production of toxic or irritant chemicals that cause human or animal health problem, 3) production of immense quantities of seed or vegetative reproductive parts or both that contaminate agricultural products and perpetuate the species in agricultural lands, and 4) production on agricultural and nonagricultural lands of vast amounts of vegetation that must be disposed of.

There are many chemical herbicides that are effective in weed management. One class of herbicides is the auxin-like herbicides. These mimic or act like natural plant growth regulators called auxins. Auxin-like herbicides appear to affect cell wall plasticity and nucleic acid metabolism, which can lead to uncontrolled cell division and growth. The injury symptoms caused by auxin-like herbicides includes epinastic bending and twisting of stems and petioles, leaf cupping and curling, and abnormal leaf shape and venation.

Adjuvants are materials that facilitate the activity of herbicides or that facilitate or modify characteristics of herbicide formulations or spray solutions. Adjuvants that increase the performance of applied herbicides when used at the recommended rate are referred to as activator adjuvants and directly enhance the activity of the pesticide or herbicide. However, no adjuvant currently used in a herbicide spray solution justifies a greatly increased price per unit, and none is so effective that the herbicide use rates can be lowered below those recommended on the herbicide label.

Herbicides can be broadly classified into two groups: pre-emergence herbicides and post-emergence herbicides. Pre-emergence herbicides are applied to soil to prevent weed seeds from germinating or before or soon after planting the crop. They may be applied to the surface of the soil or mixed with the soil. Post-emergence herbicides are used to kill weeds after they have emerged. Dicamba is an auxin-like herbicide, a member of the benzoic acid herbicide group and is an effective herbicide for both pre-emergence and post-emergence weed management. Dicamba is one of the many auxin-like herbicides that is a low-cost, environmentally friendly herbicide that has been used as a pre-emergence and post-emergence herbicide to effectively control annual and perennial broadleaf weeds and several grassy weeds in corn, sorghum, small grains, pasture, hay, rangeland, sugarcane, asparagus, turf, and grass seed crops (Crop Protection Chemicals Reference, pp. 1803-1821, Chemical & Pharmaceutical Press, Inc., New York, N.Y., 11th ed., 1995).

### BRIEF DESCRIPTION OF THE DRAWINGS

FIG. 1 shows the enhancement of dicamba herbicidal activity in the treatment of wild mustard weed with dicamba and quizalofop.

### SUMMARY OF THE INVENTION

There is now provided a herbicidal composition comprising an auxin-like herbicide and an adjuvant, wherein the effective use rate of the auxin-like herbicide is reduced relative to the herbicidal composition without the adjuvant.

There is further provided a method for inhibiting a weed growth in a field comprising treating soil in the field with an effective use rate of the herbicidal composition of the present invention.

### DETAILED DESCRIPTION

The invention relates to the surprising finding that narrowleaf active ACCase inhibitor herbicides function as adjuvants to auxin-like herbicide activity. For example an enhancement of the broadleaf herbicidal activity of dicamba/adjuvant results in a lower use rate of dicamba for weed control, this provides a new lower effective amount of dicamba that needs to be applied to a field to control sensitive weeds. This effect has been demonstrated in both pre-emergent and post-emergent applications of an auxin-like herbicide/ACCase compositions. The lower use rate will aid in managing crop injury and provide a more flexible weed control option for the farmer.

The present invention provides herbicidal compositions comprising an auxin-like herbicide and an ACCase inhibitor, wherein the composition has a reduced effective use rate of the auxin-like herbicide relative to an auxin-like herbicide composition without the ACCase inhibitor.

The “effective use rate” of an auxin-like herbicide is the amount that must be applied on a field in order to provide weed control at an economic level. An economic level for weed control is generally when the cost of the herbicide treatment is less than the crop losses due to weed growth in the field. Reducing the cost of the herbicide treatment, reducing risk of off-site movement of the applied herbicide, or reducing environmental load or herbicide residues are particularly important benefits of the invention.

In some embodiments, the effective use rate of the auxin-like herbicide in the herbicidal composition is less than or equal to 560 grams acid equivalent per hectacre, for example, less than or equal to 280 grams acid equivalent per hectacre, less than or equal to 140 grams acid equivalent per hectacre, or less than or equal to 70 grams acid equivalent per hectacre.

A sufficient amount of the adjuvant present in the composition is the amount sufficient to potentiate the herbicidal activity of the auxin-like herbicide. This amount varies with the combination of the auxin-like herbicide and particular adjuvant composition as described in the examples.

“Potentiate” means to enhance or increase the effectiveness of the auxin-like herbicide.

In some embodiments, the adjuvant provides a reduction in an amount of an auxin-like herbicide needed to provide effective weed control by about 10 percent to about 50 percent or more.

“Adjuvants” are materials that facilitate the activity of herbicides or that facilitate or modify characteristics of herbicide formulations or spray solutions.

Adjuvants of the present invention are members of the chemical molecules that function as inhibitors of acetyl CoA carboxylase (ACCase) and are known as ACCase inhibitors. ACCase inhibitors are narrowleaf weed control agents with little or no activity on broadleaf weeds.

Examples of ACCase inhibitors include without limitation aryloxyphenoxyproprionates, cyclohexanediones, and phenylpyrazolines.

Examples of aryloxyphenoxypropionates include without limitation:
clodinafop (Propanoic acid, 2-[4-[(5-chloro-3-fluoro-2-pyridinyl)oxy]phenoxy]-,2-propynyl ester, (2R)), a commercial formulation sold under the name Discover® by Syngenta Corp., Greensboro, N.C.;
cyhalofop (butyl(2R)-2-[4-(4-cyano-2-fluorophenoxy)phenoxy]propionate), a commercial formulation sold as Clincher® by Dow AgroSciences, Indianapolis, Ind.;
diclofop (methyl 2-[4-(2,4-dichlorophenoxy)phenoxy]propanoate), a commercial formulation sold as Hoegrass® by Bayer Crop Science, Research Triangle Park, N.C.;
fenoxaprop (ethyl (R)-2-[4-(6-chloro-1,3-benzoxazol-2-yloxy)phenoxy]propionate), a commercial formulation sold uner the name of PUMA® by Bayer Crop Science, Research Triangle Park, N.C.;
fluazifop (2R)-2-[4-[[5-(trifluoromethyl)-2-pyridinyl]oxy]phenoxy]propanoic acid), a commercial formulation sold under the name of Fusilade DX® by Syngenta Corp.;
haloxyfop (2-[4-[[3-chloro-5-(trifluoromethyl)-2-pyridinyl]oxy]phenoxy]propanoic acid), a commercial formulation sold under the name of Verdict® and Edge® by Dow AgroSciences, Indianapolis, Ind. and FirePower® sold by Farmoz, St Leonards NSW Australia;
propaquizafop (2-[[(1-methylethylidene)amino]oxy]ethyl (2R)-2-[4-[(6-chloro-2quinoxalinyl)oxy]phenoxy]propanoate), a commercial formulation sold under the name of Agil® by Syngenta Corp.; and
quizalofop (2R)-2-[4-[(6-chloro-2-quinoxalinyl)oxy]phenoxy]propanoic acid, a commercial formulation sold under the name ASSURE II® by Dupont Corp., Wilmington Del.;

Examples of cyclohexanediones include without limitation:
alloxydim (methyl 2,2-dimethyl-4,6-dioxo-5-[(1E)-1-[(2-propen-1-yloxy)imino]butyl]cyclohexanecarboxylate), a commercial formulation sold under the name of Fervin® by BASF Corp., Research Triangle Park, N.C.;
butroxydim (2-[1-(ethoxyimino)propyl]-3-hydroxy-5-[2,4,6-trimethyl-3-(1-oxobutyl)phenyl]-2-cyclohexen-1-one), a commercial formulation sold under the name of Falcon® sold by Syngenta Corp.;
clethodim (2-[1-[[[(2E)-3-chloro-2-propen-1-yl]oxy]imino]propyl]-5-[2-(ethylthio)propyl]-3-hydroxy-2-cyclohexen-1-one), a commercial formulation sold under the name SelectMAX® by Valent Walnut Creek, Calif.;
cycloxydim (2-[1-(ethoxyimino)butyl]-3-hydroxy-5-(tetrahydro-2H-thiopyran-3-yl)-2-cyclohexen-1-one),
profoxydim (2-[1-[[2-(4-chlorophenoxy)propoxy]imino]butyl]-3-hydroxy-5-(tetrahydro-2H-thiopyran-3-yl)-2-cyclohexen-1-one), a commercial formulation sold under the name of Aura® by BASF Corp, Research Triangle Park, N.C.;
sethoxydim (2-[1-(ethoxyimino)butyl]-5-[2-(ethylthio)propyl]-3-hydroxy-2-cyclohexen-1-one), a commercial formulation sold under the name of Poast® by BASF Corp, Research Triangle Park, N.C.;
tepraloxydim (2-[1-[[[(2E)-3-chloro-2-propen-1-yl]oxy]imino]propyl]-3-hydroxy-5-(tetrahydro-2H-pyran-4-yl)-2-cyclohexen-1-one) and
tralkoxydim (2-[1-(ethoxyimino)propyl]-3-hydroxy-5-(2,4,6-trimethylphenyl)-2-cyclohexen-1-one), a commercial formulation sold under the name of Achieve® sold by Syngenta Corp.;

Examples of phenylpyrazolines include
pinoxaden (8-(2,6-diethyl-4-methylphenyl)-1,2,4,5-tetrahydro-7-oxo-7H-pyrazolo[1,2-d][1,4,5]oxadiazepin-9-yl 2,2-dimethylpropanoate), a commercial formulation sold under the name of AxialXL® sold by Syngenta Corp.

Examples of auxin-like herbicides include without limitation benzoic acid herbicides, phenoxy herbicides, pyridine carboxylic acid herbicides, pyridine oxy herbicides, pyrimidine carboxy herbicides, quinoline carboxylic acid herbicides, and benzothiazole herbicides.

Examples of benzoic acid herbicides include without limitation dicamba, chloramben, 2,3,6-TBA and tricamba.

Dicamba refers to 3,6-dichloro-o-anisic acid or 3,6-dichloro-2-methoxy benzoic acid and its acids and salts. Examples of dicamba salts include without limitation isopropylamine, diglycoamine, dimethylamine, potassium, sodium, and MEA. Dicamba is particularly useful for control of taller weeds and more difficult to control weeds such as purslane, sicklepod, morninglory and wild buckwheat. Dicamba can be used to control weeds not susceptible to other herbicides. Following the application of Clarity, a minimum accumulation of one inch of rainfall or overhead irrigation followed by a 14 day waiting period for the 4 to 8 ounce/acre rates or a 28 day waiting period for the 16 ounce/acre rates has been recommend for controlling weeds in a soybean field. Similarly, for cotton, a waiting period of 21 days is recommended after applying Clarity® or Banvel™ to the field, before planting the cotton seeds and no pre-emergence and post-emergence application are label recommended.

Examples of a phenoxy carboxylic acid compounds include without limitation 2,4-dichlorophenoxyacetic acid, (4-chloro-2-methylphenoxy)acetic acid, diclorprop (2,4-DP), mecoprop (MCPP), and clomeprop.

Examples of pyridine herbicides include without limitation pyridine carboxylic acids and pyridine oxys. Examples of pyridine carboxylic acids include clopyralid and picloram. Examples of pyridine oxys include without limitation triclopyr and fluoroxypyr

Examples of quinoline herbicides include without limitation quinclorac and quinmerac.

Examples of pyrimidine carboxylic acid herbicide include without limitation aminocyclopyrachlor and others described in U.S. Pat. No. 7,538,214, U.S. Pat. No. 7,642,220, U.S. Pat. No. 7,833,940 and U.S. Patent Publication No. 2007/019739, all of which are herein incorporated by reference in their entirety.

An example of a benzothiazole herbicide without limitation is benzaolin-ethyl.

Examples of commercially available auxin-like herbicide formulations include without limitation 2,4-D, 2,4-DB (Butyrac® 200, Bakker), MCPA (Rhonox®, Rhomene), mecoprop, dichlorprop, 2,4,5-T, triclopyr (Garlon®, Dow AgroSciences, Indianapolis, Ind.), chloramben, dicamba (Banvel®, Clarity®, Oracle®, Sterling®), 2,3,6-TBA, tricamba, clopyralid (Stinger®, Dow AgroSciences), picloram (Tordon®, Dow Agro Sciences), quinmerac, quinclorac, benazolin, fenac, IAA, NAA, orthonil and fluoroxypyr (Vista®, Starane®, Dow AgroSciences), aminopyralid (Milestone®, Dow AgroSciences) and aminocyclopyrachlor (Dupont, Wilmington, Del.).

The preparation of herbicide compositions for use in connection with the current invention will be apparent to those of skill in the art in view of the disclosure. Such compositions will typically include, in addition to the active ingredient, components such as surfactants, solid or liquid carriers, solvents and binders.

Examples of surfactants that may be used for application to plants include the alkali metal, alkaline earth metal or ammonium salts of aromatic sulfonic acids, for example, ligno-, phenol-, naphthalene- and dibutylnaphthalenesulfonic acid, and of fatty acids of arylsulfonates, of alkyl ethers, of lauryl ethers, of fatty alcohol sulfates and of fatty alcohol glycol ether sulfates, condensates of sulfonated naphthalene and its derivatives with formaldehyde, condensates of naphthalene or of the naphthalenesulfonic acids with phenol and formaldehyde, condensates of phenol or phenolsulfonic acid with formaldehyde, condensates of phenol with formaldehyde and sodium sulfite, polyoxyethylene octylphenyl ether, ethoxylated isooctyl-, octyl- or nonylphenol, tributylphenyl polyglycol ether, alkylaryl polyether alcohols, isotridecyl alcohol, ethoxylated castor oil, ethoxylated triarylphenols, salts of phosphated triarylphenolethoxylates, lauryl alcohol polyglycol ether acetate, sorbitol esters, lignin-sulfite waste liquors or methylcellulose, or compositions of these.

In some embodiments, the herbicidal compositions contain one or more surfactants in about 0.5 to 25 percent by weight, based on the total weight of the solid composition.

Herbicidal compositions of the present invention may be in solid or liquid form. Where solid compositions are used, it may be desired to include one or more carrier materials with the active compound. Examples of carriers include mineral earths such as silicas, silica gels, silicates, talc, kaolin, attaclay, limestone, chalk, loess, clay, dolomite, diatomaceous earth, calcium sulfate, magnesium sulfate, magnesium oxide, ground synthetic materials, fertilizers such as ammonium sulfate, ammonium phosphate, ammonium nitrate, thiourea and urea, products of vegetable origin such as cereal meals, tree bark meal, wood meal and nutshell meal, cellulose powders, attapulgites, montmorillonites, mica, vermiculites, synthetic silicas and synthetic calcium silicates, or compositions of these.

For liquid solutions, water-soluble compounds or salts may be included, such as monoethanolamine salt, sodium sulfate, potassium sulfate, sodium chloride, potassium chloride, sodium acetate, ammonium hydrogen sulfate, ammonium chloride, ammonium acetate, ammonium formate, ammonium oxalate, ammonium carbonate, ammonium hydrogen carbonate, ammonium thiosulfate, ammonium hydrogen diphosphate, ammonium dihydrogen monophosphate, ammonium sodium hydrogen phosphate, ammonium thiocyanate, ammonium sulfamate or ammonium carbamate.

Other exemplary components in herbicidal compositions include binders such as polyvinylpyrrolidone, polyvinyl alcohol, partially hydrolyzed polyvinyl acetate, carboxymethylcellulose, starch, vinylpyrrolidone/vinyl acetate copolymers and polyvinyl acetate, or compositions of these; lubricants such as magnesium stearate, sodium stearate, talc or polyethylene glycol, or compositions of these; antifoams such as silicone emulsions, long-chain alcohols, phosphoric esters, acetylene diols, fatty acids or organofluorine compounds, and complexing agents such as: salts of ethylenediaminetetraacetic acid (EDTA), salts of trinitrilotriacetic acid or salts of polyphosphoric acids, or compositions of these.

The present invention also provides methods for controlling weeds in a field.

In one embodiment, a method is provided for inhibiting weed growth in a field comprising treating the soil in the field with an effective use rate of a herbicidal composition of the present invention.

In some embodiments, the effective use rate is less than 560 grams acid equivalent per hectare, for example, less than 400 grams acid equivalent per hectare, less than 350 grams acid equivalent per hectare, less than 300 grams acid equivalent per hectare, less than 280 grams acid equivalent per hectare, less than 250 grams acid equivalent per hectare, less than 200 grams acid equivalent per hectare, and less than 150 grams acid equivalent per hectare.

In some embodiments, the adjuvant is applied at a rate of between 15 and 416 grams acid equivalent per hectare, for example, between 15 and 300 grams acid equivalent per hectare, between 100 and 200 grams acid equivalent per hectare, between 15 and 70 grams acid equivalent per hectare, between 92 and 276 grams acid equivalent per hectare, between 105 and 210 grams acid equivalent per hectare, between 47 and 186 grams acid equivalent per hectare, between 68 and 272 grams acid equivalent per hectare, between 140 and 416 grams acid equivalent per hectare, between 200 and 300 grams acid equivalent per hectare, between 300 and 400 grams acid equivalent per hectare, and between 50 and 100 grams acid equivalent per hectare.

The herbicidal compositions can be applied pre-plant or post-plant. Post-plant applications may be pre-emergence or post-emergence.

Multiple applications of the herbicidal composition may be used over a growing season, for example, two applications (such as a pre-planting application, a pre-emergence application, and a post-emergence application).

In some such embodiments, the field comprises herbicide tolerant crops. These crops can be transgenic or non-transgenic.

In some embodiments, the crops are tolerant to auxin-like herbicides. Examples include without limitation dicamba and 2,4-D tolerant crops.

Soybean plants transformed with chimeric chloroplast transit peptide/dicamba monoxygenase (DMO)-encoding polynucleotide constructs (for example, as described in U.S. Patent Publication No. 2009/0029861, herein incorporated by reference) were tolerant at 2 lb/acre rates of dicamba applied post plant. One weed control strategy is to apply a herbicide such as dicamba to a field before sowing seeds. However, after applying the herbicide to a field, a farmer often must wait at least several weeks before sowing the field with crop seeds. Also 2,4-D has been recommended for controlling certain weeds in a soybean field such as mustard species, plantains, marestail, and 2,4-D susceptible annual broadleaf weeds by applying it 7 to 30 days prior to planting, depending on rate and formulation (ester or amine).

In other embodiments, the crops are tolerant to ACCase inhibiting herbicides.

Maize plants have been isolated that are tolerant to ACCase inhibiting herbicides either by selection from variant populations with an insensitive enzyme (U.S. Pat. No. 5,162,602) or by introducing a transgene into a maize plant that produces and enzyme that degrades the herbicides (U.S. Patent Publication No. 2009/0093366).

In accordance with the invention, methods and compositions for the control of weeds are provided comprising the use of plants exhibiting tolerance to dicamba and may include one or more additional herbicide tolerance traits, for example, glyphosate tolerance or glufosinate tolerance. In one embodiment, a tank mix of glyphosate and the dicamba adjuvant composition of the present invention is applied pre- and/or post-emergence to plants. Glyphosate and the dicamba adjuvant composition may additionally be applied separately. A reduction in the use rates of both herbicides may be achieved.

One method that has been used in conjunction with herbicide treatments are transgenic herbicide tolerance genes. In recent years, crops tolerant to several herbicides have been developed through this manner. For examples, crops tolerant to 2,4-dichlorophenoxyacetic acid (U.S. Patent Publication No. 2009/0093366, herein incorporated by reference), bromoxynil (U.S. Pat. No. 4,810,648, herein incorporated by reference), glyphosate (U.S. Pat. RE39,247, herein incorporated by reference) and phosphinothricin (U.S. Pat. No. 6,395,966, herein incorporated by reference) have been developed and commercialized. A gene for dicamba monooxygenase (DMO) was isolated from Pseuodmonas maltophilia (U.S. Pat. No. 7,022,896, herein incorporated by reference) which is involved in the conversion of an auxin-like herbicide dicamba (3,6-dichloro-o-anisic acid) to a non-toxic 3,6-dichlorosalicylic acid and a dicamba tolerant soybean plant MON87708 comprising the DMO enzyme (US Publication No. 2011/0067134), which is in development for commercial introduction.

Any of the techniques known in the art for introduction of transgenes into plants may be used to prepare a herbicide tolerant plant in accordance with the invention. Suitable methods for transformation of plants are believed to include virtually any method by which DNA can be introduced into a cell, such as by direct delivery of DNA such as by PEG-mediated transformation of protoplasts, by desiccation/inhibition-mediated DNA uptake, by electroporation (U.S. Pat. No. 5,384,253), by agitation with silicon carbide (U.S. Pat. No. 5,302,523; and U.S. Pat. No. 5,464,765), by Agrobacterium-mediated transformation (U.S. Pat. No. 5,591,616 and U.S. Pat. No. 5,563,055) and by acceleration of DNA coated particles (U.S. Pat. No. 5,550,318; U.S. Pat. No. 5,538,877; and U.S. Pat. No. 5,538,880). Through the application of techniques such as these, the cells of virtually any plant species may be stably transformed, and these cells developed into transgenic plants.

Once a transgene has been introduced into a plant, that gene can be introduced into any plant sexually compatible with the first plant by crossing using conventional methods of plant breeding. Therefore, as used herein the term “progeny” denotes the offspring of any generation of a parent plant. A “transgenic plant” may thus be of any generation. “Crossing” a plant to provide a plant line having one or more added transgenes or alleles relative to a starting plant line, as disclosed herein, is defined as the techniques that result in a particular gene or trait being introduced into a plant progeny by crossing a first parent line with a second plant line that comprises a transgene or trait. To achieve this one could, for example, perform the following steps: (a) plant seeds of the first parent and second parent plants; (b) grow the seeds of the first and second parent plants into plants that bear flowers; (c) pollinate a flower from the first parent plant with pollen from the second parent plant; and (d) harvest seeds produced on the parent plant bearing the fertilized flower.

In some embodiments, the weeds include broadleaf weeds. Broadleaf weeds are plants that botantically are identified as dicotylendenous plants. They are weeds if they are growing and competing with crop plants or interfere with management objectives for a given area of land at a given point in time. Examples of broadleaf weeds include, but are not limited to velvetleaf Abutilon theophrasti, common lambsquarters Chenopodium album, wild poinsettia Euphorbia heterophylla, wild mustard Sinapis arvensis, Palmer amaranth Amaranthus palmeri, waterhemp Amaranthus rudis/tamariscinus, horseweed (marestail) Conyza canadensis, morningglory Ipomea species, sicklepod Senna obtusifolia, purselane Portulaca oleracea, benghal dayflower Commelina benghalensis, beggarticks Bidens species, redroot pigweed Amaranthus retroflexus, cocklebur Xanthium strumarium, nightshade Solanum nigrum, and black bindweed Fallopia convolvulus.

In other embodiments, the weeds include narrowleaf weeds.

In yet other embodiments, the weeds include glyphosate tolerant crops. Commercially available transgenic glyphosate tolerant broadleaf crops include but are not limited to soybean 40-3-2, soybean MON89788, cotton 1445, cotton MON88913, canola RT73, sugarbeet H7-1, alfalfa J101 and J163.

### EXAMPLES

The following examples are merely illustrative, and not limiting to the disclosure in any way.

Commercially available ACCase inhibito formulations were used in the following Examples. Examples of such formulations include without limitation clethodim (Selectmax®), clodinafop (Discover NG®), dicamba (Clarity®, BASF, Research Triangle Park, N.C.), diclofop (Hoegrass® by Bayer Crop Science, Research Triangle Park, N.C.), fenoxaprop-P-ethyl (Puma®), fluazifop-P-butyl (Fusilade DX®), glyphosate (Roundup PowerMax®, Monsanto Co., St Louis, Mo.), haloxyfop (Firepower®, Farmoz, St Leonards NSW Australia), pinoxaden (Axial XL®), and quizalofop (Assure II®).

In the following data tables in which ANOVA analysis (http://www.physics.csbsju.edu/stats/anova.html) is provided, levels not connected by the same letter are significantly different.

### Example 1

### Tank Mix Application of Herbicidal Compositions on Velvetleaf

Velvetleaf seeds (Abutilon theophrasti) obtained from Herbiseed Co. (Cat#91002, Twyford, England, UK) were planted in 3.5 inch square plastic pots filled with Redi-Earth (Sun Gro, Bellevue, Wash.) containing 100 gram/cubic foot Osmocote 14-14-14 slow release fertilizer. Ten to fifteen velvetleaf seeds were planted about one half inch deep and loosely covered with the Redi-Earth potting media. The pots were placed in a controlled environment equipped with sub-irrigation. Growth conditions were 27° C. day and 21° C. night with fourteen (14) hours of supplemental light (approximately 600 microeinsteins). After germination and emergence from the potting media, the plants were thinned to achieve one plant per pot. Pots that contained plants that were similar in appearance, size and vigor were selected for the treatments.

Herbicidal compositions were prepared by tank mixing the ACCase inhibitor with Clarity® using a complete 3×3 factorial design (3 rates of Clarity® by 3 rates of each adjuvant). The herbicidal compositions and the application rates in grams acid equivalent/hectare (g/ae/ha) are shown in Tables 1-5. Typically, the plants were four to eight inches tall when the herbicide treatments are applied. Compositions were applied to the plants with a track sprayer generally using a Teejet 9501E flat fan nozzle or similar nozzle with air pressure set at a minimum of 24 pounds per square inch. The spray nozzle was 16 inches above the top of the plants and a spray volume rate of approximately 10 gallons per acre (93 liters per hectare) was applied. Weed control ratings were made 14 to 21 days post treatment, a time that should provide maximum or near maximum herbicide effect. The results are shown in Tables 1-5.

TABLE 1
Velvetleaf Control

| | Rate | | Rate | Velvetleaf | |
|---|---|---|---|---|---|
| Auxin | (g/ | ACCase | (g/ | Control | |
| Herbicide | ae/ha) | Inhibitor | ae/ha) | (%) | ANOVA |
| Clarity ® | 140 | — | — | 50 | e |
| Clarity ® | 280 | — | — | 67.5 | f |
| Clarity ® | 560 | — | — | 89.2 | d |
| — | — | Assure II ® | 15 | 0.0 | f |
| — | — | Assure II ® | 60 | 0.0 | g |
| — | — | Assure II ® | 240 | 0.0 | f |
| — | — | Discover NG ® | 15 | 0.0 | f |
| — | — | Discover NG ® | 60 | 0.0 | g |
| — | — | Discover NG ® | 240 | 0.0 | f |
| — | — | SelectMax ® | 15 | 0.0 | f |
| — | — | SelectMax ® | 60 | 0.0 | g |
| — | — | SelectMax ® | 240 | 0.0 | f |
| Clarity ® | 140 | Assure II ® | 15 | 60.0 | d |
| Clarity ® | 280 | Assure II ® | 15 | 67.5 | f |
| Clarity ® | 560 | Assure II ® | 15 | 92.5 | bcd |
| Clarity ® | 140 | Assure II ® | 60 | 61.7 | cd |
| Clarity ® | 280 | Assure II ® | 60 | 77.5 | cd |
| Clarity ® | 560 | Assure II ® | 60 | 90.0 | d |
| Clarity ® | 140 | Assure II ® | 240 | 72.5 | b |
| Clarity ® | 280 | Assure II ® | 240 | 74.2 | de |
| Clarity ® | 560 | Assure II ® | 240 | 91.7 | cd |
| Clarity ® | 140 | Discover NG ® | 15 | 51.7 | e |
| Clarity ® | 280 | Discover NG ® | 15 | 67.5 | f |
| Clarity ® | 560 | Discover NG ® | 15 | 91.7 | cd |
| Clarity ® | 140 | Discover NG ® | 60 | 64.2 | cd |
| Clarity ® | 280 | Discover NG ® | 60 | 88.3 | b |
| Clarity ® | 560 | Discover NG ® | 60 | 95.5 | ab |
| Clarity ® | 140 | Discover NG ® | 240 | 85.0 | a |
| Clarity ® | 280 | Discover NG ® | 240 | 93.3 | a |
| Clarity ® | 560 | Discover NG ® | 240 | 96.0 | a |
| Clarity ® | 140 | SelectMax ® | 15 | 51.7 | e |
| Clarity ® | 280 | SelectMax ® | 15 | 68.3 | f |
| Clarity ® | 560 | SelectMax ® | 15 | 84.2 | e |
| Clarity ® | 140 | SelectMax ® | 60 | 52.5 | e |
| Clarity ® | 280 | SelectMax ® | 60 | 70.8 | ef |
| Clarity ® | 560 | SelectMax ® | 60 | 90.8 | cd |
| Clarity ® | 140 | SelectMax ® | 240 | 65.8 | c |
| Clarity ® | 280 | SelectMax ® | 240 | 80.8 | c |
| Clarity ® | 560 | SelectMax ® | 240 | 94.2 | abc |

Tank mix combinations of Clarity® at 140 g ae/ha plus Assure II® at all test rates (15, 60, 240 g ae/ha), Discover NG® at 60 and 240, and Selectmax® 240 showed increased injury to velvetleaf compared to Clarity® at 140 g ae/ha alone. The data indicates that improved efficacy of dicamba herbicide activity can be achieved when tank mixed with any of these tested ACCase inhibitor products that function as activity enhancing adjuvants. Several tank mix combinations of Clarity® and clodinafop (Discover NG®) provided dramatic efficacy improvement when compared to Clarity® alone.

TABLE 2
Velvetleaf Control

| | Rate | | Rate | Velvetleaf | |
|---|---|---|---|---|---|
| Auxin | (g/ | ACCase | (g/ | Control | |
| Herbicide | ae/ha) | Inhibitor | ae/ha) | (%) | ANOVA |
| Clarity ® | 140 | — | — | 53.3 | g |
| Clarity ® | 280 | — | — | 80.0 | b |
| Clarity ® | 560 | — | — | 91.7 | ef |
| — | — | Fusilade DX ® | | 0.0 | h |
| — | — | Fusilade DX ® | | 0.0 | c |
| — | — | Fusilade DX ® | | 0.0 | g |
| — | — | Puma ® | | 0.0 | h |
| — | — | Puma ® | | 0.0 | c |
| — | — | Puma ® | | 0.0 | g |
| — | — | Axial XL ® | | 0.0 | h |
| — | — | Axial XL ® | | 0.0 | c |
| — | — | Axial XL ® | | 0.0 | g |
| Clarity ® | 140 | Fusilade DX ® | 105 | 62.5 | de |
| Clarity ® | 280 | Fusilade DX ® | 105 | 87.5 | a |
| Clarity ® | 560 | Fusilade DX ® | 105 | 94.2 | cde |
| Clarity ® | 140 | Fusilade DX ® | 210 | 70.0 | bc |
| Clarity ® | 280 | Fusilade DX ® | 210 | 93.3 | a |
| Clarity ® | 560 | Fusilade DX ® | 210 | 93.8 | cdef |
| Clarity ® | 140 | Fusilade DX ® | 630 | 82.5 | a |
| Clarity ® | 280 | Fusilade DX ® | 630 | 93.3 | a |
| Clarity ® | 560 | Fusilade DX ® | 630 | 97.5 | ab |
| Clarity ® | 140 | Puma ® | 46 | 56.7 | fg |
| Clarity ® | 280 | Puma ® | 46 | 80.0 | b |
| Clarity ® | 560 | Puma ® | 46 | 93.7 | def |
| Clarity ® | 140 | Puma ® | 92 | 65.8 | cd |
| Clarity ® | 280 | Puma ® | 92 | 80.0 | b |
| Clarity ® | 560 | Puma ® | 92 | 90.8 | f |
| Clarity ® | 140 | Puma ® | 276 | 70.8 | bc |
| Clarity ® | 280 | Puma ® | 276 | 93.3 | a |
| Clarity ® | 560 | Puma ® | 276 | 95.5 | bcd |
| Clarity ® | 140 | Axial XL ® | 18 | 59.2 | ef |
| Clarity ® | 280 | Axial XL ® | 18 | 77.5 | b |
| Clarity ® | 560 | Axial XL ® | 18 | 97.3 | ab |
| Clarity ® | 140 | Axial XL ® | 36 | 74.2 | b |
| Clarity ® | 280 | Axial XL ® | 36 | 90.8 | a |
| Clarity ® | 560 | Axial XL ® | 36 | 96.8 | abc |
| Clarity ® | 140 | Axial XL ® | 108 | 72.5 | b |
| Clarity ® | 280 | Axial XL ® | 108 | 92.5 | a |
| Clarity ® | 560 | Axial XL ® | 108 | 99.8 | a |

All tank mix combinations of Clarity® at 140 g ae/ha plus all ACCase inhibitors at all test rates except Puma® 46 g provided a statistically significant improvement in velvetleaf control compared to Clarity® at 140 g ae/ha alone in this test. Tank mix combinations of Clarity® at 280 g ae/ha and Fusilade DX® at all test rates, Puma® 276 g, and Axial XL® 36, 108 g provided a statistically significant improvement in velvetleaf control compared to Clarity® at 280 g ae/ha alone. All other TM combinations at this rate provided equivalent control to Clarity® alone. Tank mix combinations of Clarity® at 560 g ae/ha and Fusilade DX®-630 g, Puma® 276 g, and Axial XL® 18, 36, 108 g provided a statistically significant improvement in velvetleaf weed control compared to Clarity® at 560 g ae/ha alone. All other TM combinations at this rate provided equivalent control to Clarity® alone. The data indicates that improved efficacy of dicamba herbicide activity can be achieved when tank mixed with any of these tested ACCase inhibitor products that function as activity enhancing adjuvants.

Glyphosate (Roundup PowerMax®, RPMax) at 3 rates (140, 280 and 560 g/ae/ha) combined with dicamba (Clarity®) at 3 rates (140, 280 and 560 g/ae/ha) combined with quizalofop (Assure IF)) at 3 rates (46, 92, and 184 g/ae/ha) or clethodim (SelectMax®) at 3 rates (68, 135, and 270 g/ae/ha) or clodinafop (Discover NG®) at 3 rates (40, 80 and 160 g/ae/ha) or fenoxaprop (Puma®) at 3 rates (47, 94, 188 g/ae/ha) were tested for enhanced herbicidal activity on velvetleaf weed. The compositions were combinded in a tank mix and applied to velvetleaf plants as previously described and scored for injury to the velvetleaf plants. The results shown in Table 3 and 4 demonstrate that adding the ACCase inhibitors to a tank mix of glyphosate and dicamba can reduce the amount of glyphosate/dicamba mixture needed in the tank mix to provide a high level of activity on weeds.

TABLE 3
Velvetleaf Control

| Auxin | Rate | ACCase | Rate | Glyphosate | Glyphosate | Velvetleaf | |
|---|---|---|---|---|---|---|---|
| Herbicide | (g/ae/ha) | Inhibitor | (g/ae/ha) | Formulation | Rate | Control (%) | ANOVA |
| — | — | — | — | Roundup | 140 | 9.2 | e |
| | | | | PowerMax ® | | | |
| — | — | — | — | Roundup | 280 | 63.3 | d |
| | | | | PowerMax ® | | | |
| — | — | — | — | Roundup | 560 | 86.5 | c |
| | | | | PowerMax ® | | | |
| — | — | Assure II ® | 46 | — | — | 0.0 | f |
| — | — | Assure II ® | 92 | — | — | 0.0 | e |
| — | — | Assure II ® | 184 | — | — | 0.0 | d |
| — | — | SelectMax ® | 68 | — | — | 0.0 | f |
| — | — | SelectMax ® | 135 | — | — | 0.0 | e |
| — | — | SelectMax ® | 270 | — | — | 0.0 | d |
| Clarity ® | 140 | — | — | — | — | 61.7 | d |
| Clarity ® | 280 | — | — | — | — | 88.8 | c |
| Clarity ® | 560 | — | — | — | — | 96.8 | b |
| Clarity ® | 140 | Assure II ® | 46 | Roundup | 140 | 70.0 | c |
| | | | | PowerMax ® | | | |
| Clarity ® | 280 | Assure II ® | 46 | Roundup | 280 | 92.5 | bc |
| | | | | PowerMax ® | | | |
| Clarity ® | 560 | Assure II ® | 46 | Roundup | 560 | 99.5 | ab |
| | | | | PowerMax ® | | | |
| Clarity ® | 140 | Assure II ® | 92 | Roundup | 140 | 80.0 | b |
| | | | | PowerMax ® | | | |
| Clarity ® | 280 | Assure II ® | 92 | Roundup | 280 | 98.8 | a |
| | | | | PowerMax ® | | | |
| Clarity ® | 560 | Assure II ® | 92 | Roundup | 560 | 100.0 | a |
| | | | | PowerMax ® | | | |
| Clarity ® | 140 | Assure II ® | 184 | Roundup | 140 | 90.0 | a |
| | | | | PowerMax ® | | | |
| Clarity ® | 280 | Assure II ® | 184 | Roundup | 280 | 95.0 | ab |
| | | | | PowerMax ® | | | |
| Clarity ® | 560 | Assure II ® | 184 | Roundup | 560 | 100.0 | a |
| | | | | PowerMax ® | | | |
| Clarity ® | 140 | SelectMax ® | 68 | Roundup | 140 | 75.0 | bc |
| | | | | PowerMax ® | | | |
| Clarity ® | 280 | SelectMax ® | 68 | Roundup | 280 | 94.8 | ab |
| | | | | PowerMax ® | | | |
| Clarity ® | 560 | SelectMax ® | 68 | Roundup | 560 | 99.0 | ab |
| | | | | PowerMax ® | | | |
| Clarity ® | 140 | SelectMax ® | 135 | Roundup | 140 | 80.8 | b |
| | | | | PowerMax ® | | | |
| Clarity ® | 280 | SelectMax ® | 135 | Roundup | 280 | 97.2 | a |
| | | | | PowerMax ® | | | |
| Clarity ® | 560 | SelectMax ® | 135 | Roundup | 560 | 99.7 | a |
| | | | | PowerMax ® | | | |
| Clarity ® | 140 | SelectMax ® | 270 | Roundup | 140 | 80.8 | b |
| | | | | PowerMax ® | | | |
| Clarity ® | 280 | SelectMax ® | 270 | Roundup | 280 | 98.2 | a |
| | | | | PowerMax ® | | | |
| Clarity ® | 560 | SelectMax ® | 270 | Roundup | 560 | 99.7 | a |
| | | | | PowerMax ® | | | |

TABLE 4
Velvetleaf Control

| | Rate | | Rate | Glyphosate | | Velvetleaf | |
|---|---|---|---|---|---|---|---|
| Auxin | (g/ae/ | ACCase | (g/ae/ | Herbicide | | Control | |
| Herbicide | ha) | Inhibitor | ha) | Formulation | Rate | (%) | ANOVA |
| — | — | — | — | Roundup | 140 | 38.3 | e |
| | | | | PowerMax ® | | | |
| — | — | — | — | Roundup | 280 | 55.8 | d |
| | | | | PowerMax ® | | | |
| — | — | — | — | Roundup | 560 | 82.5 | b |
| | | | | PowerMax ® | | | |
| — | — | Discover NG ® | 40 | — | — | 0.0 | f |
| — | — | Discover NG ® | 80 | — | — | 0.0 | e |
| — | — | Discover NG ® | 160 | — | — | 0.0 | c |
| — | — | Puma ® | 47 | — | — | 0.0 | f |
| — | — | Puma ® | 94 | — | — | 0.0 | e |
| — | — | Puma ® | 188 | — | — | 0.0 | c |
| Clarity ® | 140 | — | — | — | — | 56.7 | d |
| Clarity ® | 280 | — | — | — | — | 85.8 | c |
| Clarity ® | 560 | — | — | — | — | 100.0 | a |
| Clarity ® | 140 | Discover NG ® | 40 | Roundup | 140 | 70.0 | c |
| | | | | PowerMax ® | | | |
| Clarity ® | 280 | Discover NG ® | 40 | Roundup | 280 | 94.7 | b |
| | | | | PowerMax ® | | | |
| Clarity ® | 560 | Discover NG ® | 40 | Roundup | 560 | 100.0 | a |
| | | | | PowerMax ® | | | |
| Clarity ® | 140 | Discover NG ® | 80 | Roundup | 140 | 89.2 | b |
| | | | | PowerMax ® | | | |
| Clarity ® | 280 | Discover NG ® | 80 | Roundup | 280 | 100.0 | a |
| | | | | PowerMax ® | | | |
| Clarity ® | 560 | Discover NG ® | 80 | Roundup | 560 | 100.0 | a |
| | | | | PowerMax ® | | | |
| Clarity ® | 140 | Discover NG ® | 160 | Roundup | 140 | 94.2 | ab |
| | | | | PowerMax ® | | | |
| Clarity ® | 280 | Discover NG ® | 160 | Roundup | 280 | 100.0 | a |
| | | | | PowerMax ® | | | |
| Clarity ® | 560 | Discover NG ® | 160 | Roundup | 560 | 100.0 | a |
| | | | | PowerMax ® | | | |
| Clarity ® | 140 | Puma ® | 47 | Roundup | 140 | 76.7 | c |
| | | | | PowerMax ® | | | |
| Clarity ® | 280 | Puma ® | 47 | Roundup | 280 | 95.8 | b |
| | | | | Puma ® Power | | | |
| | | | | Max ® | | | |
| Clarity ® | 560 | Puma ® | 47 | Roundup | 560 | 100.0 | a |
| | | | | PowerMax ® | | | |
| Clarity ® | 140 | Puma ® | 94 | Roundup | 140 | 88.3 | b |
| | | | | PowerMax ® | | | |
| Clarity ® | 280 | Puma ® | 94 | Roundup | 280 | 100.0 | a |
| | | | | PowerMax ® | | | |
| Clarity ® | 560 | Puma ® | 94 | Roundup | 560 | 100.0 | a |
| | | | | PowerMax ® | | | |
| Clarity ® | 140 | Puma ® | 188 | Roundup | 140 | 96.7 | a |
| | | | | PowerMax ® | | | |
| Clarity ® | 280 | Puma ® | 188 | Roundup | 280 | 100.0 | a |
| | | | | PowerMax ® | | | |
| Clarity ® | 560 | Puma ® | 188 | Roundup | 560 | 100.0 | a |
| | | | | PowerMax ® | | | |

TABLE 5
Velvetleaf Control

| | Rate | | Rate | Velvetleaf | |
|---|---|---|---|---|---|
| Auxin | (g/ | ACCase | (g/ | Control | |
| Herbicide | ae/ha) | Inhibitor | ae/ha) | (%) | ANOVA |
| Clarity ® | 140 | — | — | 56.7 | d |
| Clarity ® | 280 | — | — | 92.3 | c |
| Clarity ® | 560 | — | — | 100.0 | a |
| — | — | Discover NG ® | 40 | 0.2 | e |
| — | — | Discover NG ® | 80 | 0.3 | d |
| — | — | Discover NG ® | 160 | 0.5 | b |
| — | — | Firepower ® | 140 | 0.2 | e |
| — | — | Firepower ® | 208 | 0.3 | d |
| — | — | Firepower ® | 416 | 0.5 | b |
| Clarity ® | 140 | Discover NG ® | 40 | 63.3 | c |
| Clarity ® | 280 | Discover NG ® | 40 | 94.3 | bc |
| Clarity ® | 560 | Discover NG ® | 40 | 100.0 | a |
| Clarity ® | 140 | Discover NG ® | 80 | 90.0 | a |
| Clarity ® | 280 | Discover NG ® | 80 | 99.2 | a |
| Clarity ® | 560 | Discover NG ® | 80 | 100.0 | a |
| Clarity ® | 140 | Discover NG ® | 160 | 93.3 | a |
| Clarity ® | 280 | Discover NG ® | 160 | 98.2 | a |
| Clarity ® | 560 | Discover NG ® | 160 | 100.0 | a |
| Clarity ® | 140 | Firepower ® | 140 | 83.3 | b |
| Clarity ® | 280 | Firepower ® | 140 | 97.7 | ab |
| Clarity ® | 560 | Firepower ® | 140 | 100.0 | a |
| Clarity ® | 140 | Firepower ® | 208 | 90.8 | a |
| Clarity ® | 280 | Firepower ® | 208 | 99.0 | a |
| Clarity ® | 560 | Firepower ® | 208 | 100.0 | a |
| Clarity ® | 140 | Firepower ® | 416 | 94.7 | a |
| Clarity ® | 280 | Firepower ® | 416 | 98.8 | a |
| Clarity ® | 560 | Firepower ® | 416 | 100.0 | a |

The data indicates that haloxyfop (Firepower®) provides as much of an enhancement to dicamba efficacy as does clodinafop (Discover NG®) when applied in tank-mix applications.

### Example 2

### Foliar Application of Herbicidal Compositions on Velvetleaf

The dicamba adjuvant efficacy was tested on various weed species as foliar treatments using essentially the same protocol as described in Example 1 for treatment of velvetleaf weed. The various weeds species can be obtained from Herbiseed Co. (Twyford, England, UK).

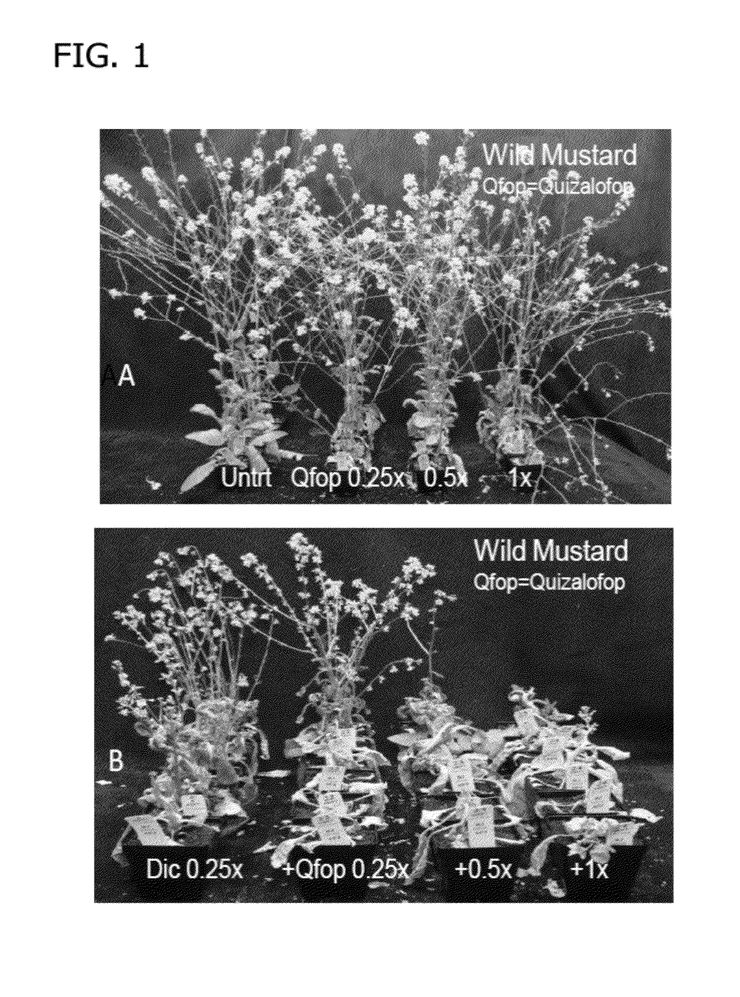

Tested in this example were common lambsquarters (Chenopodium album) Table 6., redroot pigweed (Amaranthus retroflexus) Table 7., sicklepod (Senna obtusifolia) Table 8., purselane (Portulaca oleracea) Table 9., wild poinsettia (Euphorbia heterophylla) Table 10., wild mustard (Sinapis arvensis) Table 11. and FIG. 1, glyphosate resistant (GR) Palmer pigweed (Amaranthus palmeri) Table 12., glyphosate resistant (GR) horseweed (Conyza canadensis) Table 13., and waterhemp (Amaranthus rudis/tamariscinus) Table 14. Treatment of various weed species with a dicamba/adjuvant composition of the present invention have shown an unexpected enhancement of the dicamba activity against a variety of important weed species including at least two glyphosate resistant weed species.

TABLE 6
Lambsquarter Control.

| | | | | Lambs- | |
|---|---|---|---|---|---|
| | Rate | | Rate | quarter | |
| Auxin | (g/ | ACCase | (g/ | Control | |
| Herbicide | ae/ha) | Inhibitor | ae/ha) | (%) | ANOVA |
| Clarity ® | 140 | — | — | 28.3 | e |
| Clarity ® | 280 | — | — | 59.2 | c |
| Clarity ® | 560 | — | — | 87.3 | b |
| — | — | Assure II ® | 15 | 0.0 | f |
| — | — | Assure II ® | 60 | 0.0 | d |
| — | — | Assure II ® | 240 | 0.0 | c |
| — | — | Discover NG ® | 15 | 0.0 | f |
| — | — | Discover NG ® | 60 | 0.0 | d |
| — | — | Discover NG ® | 240 | 0.0 | c |
| — | — | Selectmax ® | 15 | 0.0 | f |
| — | — | Selectmax ® | 60 | 0.0 | d |
| — | — | Selectmax ® | 240 | 0.0 | c |
| Clarity ® | 140 | Assure II ® | 15 | 57.5 | d |
| Clarity ® | 280 | Assure II ® | 15 | 80.8 | b |
| Clarity ® | 560 | Assure II ® | 15 | 99.2 | a |
| Clarity ® | 140 | Assure II ® | 60 | 83.3 | bc |
| Clarity ® | 280 | Assure II ® | 60 | 92.5 | a |
| Clarity ® | 560 | Assure II ® | 60 | 100.0 | a |
| Clarity ® | 140 | Assure II ® | 240 | 87.5 | ab |
| Clarity ® | 280 | Assure II ® | 240 | 98.3 | a |
| Clarity ® | 560 | Assure II ® | 240 | 99.7 | a |
| Clarity ® | 140 | Discover NG ® | 15 | 75.0 | c |
| Clarity ® | 280 | Discover NG ® | 15 | 85.0 | b |
| Clarity ® | 560 | Discover NG ® | 15 | 99.0 | a |
| Clarity ® | 140 | Discover NG ® | 60 | 86.5 | ab |
| Clarity ® | 280 | Discover NG ® | 60 | 99.0 | a |
| Clarity ® | 560 | Discover NG ® | 60 | 100.0 | a |
| Clarity ® | 140 | Discover NG ® | 240 | 94.8 | a |
| Clarity ® | 280 | Discover NG ® | 240 | 99.7 | a |
| Clarity ® | 560 | Discover NG ® | 240 | 100.0 | a |
| Clarity ® | 140 | Selectmax ® | 15 | 61.7 | d |
| Clarity ® | 280 | Selectmax ® | 15 | 83.3 | b |
| Clarity ® | 560 | Selectmax ® | 15 | 98.3 | a |
| Clarity ® | 140 | Selectmax ® | 60 | 88.3 | ab |
| Clarity ® | 280 | Selectmax ® | 60 | 99.0 | a |
| Clarity ® | 560 | Selectmax ® | 60 | 100.0 | a |
| Clarity ® | 140 | Selectmax ® | 240 | 88.2 | ab |
| Clarity ® | 280 | Selectmax ® | 240 | 99.2 | a |
| Clarity ® | 560 | Selectmax ® | 240 | 100.0 | a |

TABLE 7
Pigweed Control.

| | Rate | | Rate | Pigweed | |
|---|---|---|---|---|---|
| Auxin | (g/ | ACCase | (g/ | Control | |
| Herbicide | ae/ha) | Inhibitor | ae/ha) | (%) | ANOVA |
| Clarity ® | 140 | — | — | 74.8 | ab |
| Clarity ® | 280 | — | — | 85.8 | c |
| Clarity ® | 560 | — | — | 99.0 | a |
| — | — | Assure II ® | 15 | 0.0 | c |
| — | — | Assure II ® | 60 | 6.7 | d |
| — | — | Assure II ® | 240 | 5.8 | b |
| — | — | Discover NG ® | 15 | 0.0 | c |
| — | — | Discover NG ® | 60 | 1.7 | d |
| — | — | Discover NG ® | 240 | 4.2 | b |
| — | — | Selectmax ® | 15 | 6.7 | c |
| — | — | Selectmax ® | 60 | 5.0 | d |
| — | — | Selectmax ® | 240 | 5.0 | b |
| Clarity ® | 140 | Assure II ® | 15 | 70.8 | b |
| Clarity ® | 280 | Assure II ® | 15 | 89.2 | bc |
| Clarity ® | 560 | Assure II ® | 15 | 96.5 | a |
| Clarity ® | 140 | Assure II ® | 60 | 80.8 | a |
| Clarity ® | 280 | Assure II ® | 60 | 89.2 | bc |
| Clarity ® | 560 | Assure II ® | 60 | 96.7 | a |
| Clarity ® | 140 | Assure II ® | 240 | 80.0 | ab |
| Clarity ® | 280 | Assure II ® | 240 | 95.0 | ab |
| Clarity ® | 560 | Assure II ® | 240 | 99.8 | a |
| Clarity ® | 140 | Discover NG ® | 15 | 74.2 | ab |
| Clarity ® | 280 | Discover NG ® | 15 | 91.3 | abc |
| Clarity ® | 560 | Discover NG ® | 15 | 98.0 | a |
| Clarity ® | 140 | Discover NG ® | 60 | 74.2 | ab |
| Clarity ® | 280 | Discover NG ® | 60 | 96.7 | a |
| Clarity ® | 560 | Discover NG ® | 60 | 98.3 | a |
| Clarity ® | 140 | Discover NG ® | 240 | 81.7 | a |
| Clarity ® | 280 | Discover NG ® | 240 | 98.3 | a |
| Clarity ® | 560 | Discover NG ® | 240 | 96.3 | a |
| Clarity ® | 140 | Selectmax ® | 15 | 72.5 | ab |
| Clarity ® | 280 | Selectmax ® | 15 | 93.2 | ab |
| Clarity ® | 560 | Selectmax ® | 15 | 99.7 | a |
| Clarity ® | 140 | Selectmax ® | 60 | 72.2 | ab |
| Clarity ® | 280 | Selectmax ® | 60 | 93.2 | ab |
| Clarity ® | 560 | Selectmax ® | 60 | 99.7 | a |
| Clarity ® | 140 | Selectmax ® | 240 | 80.0 | ab |
| Clarity ® | 280 | Selectmax ® | 240 | 92.5 | abc |
| Clarity ® | 560 | Selectmax ® | 240 | 99.3 | a |

TABLE 8
Sicklepod Control.

| | Rate | | Rate | Sicklepod | |
|---|---|---|---|---|---|
| Auxin | (g/ | ACCase | (g/ | Control | |
| Herbicide | ae/ha) | Inhibitor | ae/ha) | (%) | ANOVA |
| Clarity ® | 140 | — | — | 30.0 | d |
| Clarity ® | 280 | — | — | 59.2 | d |
| Clarity ® | 560 | — | — | 85.0 | de |
| — | — | Assure II ® | 15 | 0.0 | e |
| — | — | Assure II ® | 60 | 0.0 | e |
| — | — | Assure II ® | 240 | 0.0 | f |
| — | — | Discover NG ® | 15 | 0.0 | e |
| — | — | Discover NG ® | 60 | 0.0 | e |
| — | — | Discover NG ® | 240 | 0.0 | f |
| — | — | Selectmax ® | 15 | 0.0 | e |
| — | — | Selectmax ® | 60 | 0.0 | e |
| — | — | Selectmax ® | 240 | 0.0 | f |
| Clarity ® | 140 | Assure II ® | 15 | 34.2 | cd |
| Clarity ® | 280 | Assure II ® | 15 | 66.7 | bcd |
| Clarity ® | 560 | Assure II ® | 15 | 95.5 | a |
| Clarity ® | 140 | Assure II ® | 60 | 56.7 | a |
| Clarity ® | 280 | Assure II ® | 60 | 77.5 | ab |
| Clarity ® | 560 | Assure II ® | 60 | 94.7 | ab |
| Clarity ® | 140 | Assure II ® | 240 | 47.5 | ab |
| Clarity ® | 280 | Assure II ® | 240 | 72.5 | abc |
| Clarity ® | 560 | Assure II ® | 240 | 95.8 | a |
| Clarity ® | 140 | Discover NG ® | 15 | 38.3 | bcd |
| Clarity ® | 280 | Discover NG ® | 15 | 65.8 | cd |
| Clarity ® | 560 | Discover NG ® | 15 | 93.0 | abc |
| Clarity ® | 140 | Discover NG ® | 60 | 38.3 | bcd |
| Clarity ® | 280 | Discover NG ® | 60 | 69.2 | abcd |
| Clarity ® | 560 | Discover NG ® | 60 | 90.0 | bcd |
| Clarity ® | 140 | Discover NG ® | 240 | 47.5 | ab |
| Clarity ® | 280 | Discover NG ® | 240 | 79.8 | a |
| Clarity ® | 560 | Discover NG ® | 240 | 93.2 | abc |
| Clarity ® | 140 | Selectmax ® | 15 | 40.0 | bcd |
| Clarity ® | 280 | Selectmax ® | 15 | 59.2 | d |
| Clarity ® | 560 | Selectmax ® | 15 | 84.2 | e |
| Clarity ® | 140 | Selectmax ® | 60 | 44.2 | abc |
| Clarity ® | 280 | Selectmax ® | 60 | 70.8 | abc |
| Clarity ® | 560 | Selectmax ® | 60 | 88.3 | cde |
| Clarity ® | 140 | Selectmax ® | 240 | 42.5 | bcd |
| Clarity ® | 280 | Selectmax ® | 240 | 72.5 | abc |
| Clarity ® | 560 | Selectmax ® | 240 | 94.2 | ab |

TABLE 9
Purselane Control.

| | Rate | | Rate | Purselane | |
|---|---|---|---|---|---|
| Auxin | (g/ | ACCase | (g/ | Control | |
| Herbicide | ae/ha) | Inhibitor | ae/ha) | (%) | ANOVA |
| Clarity ® | 140 | — | — | 57.5 | d |
| Clarity ® | 280 | — | — | 82.5 | c |
| Clarity ® | 560 | — | — | 94.7 | a |
| — | — | Assure II ® | 15 | 35.0 | e |
| — | — | Assure II ® | 60 | 37.5 | d |
| — | — | Assure II ® | 240 | 37.5 | b |
| — | — | Discover NG ® | 15 | 20.8 | f |
| — | — | Discover NG ® | 60 | 15.8 | e |
| — | — | Discover NG ® | 240 | 25.0 | c |
| — | — | Selectmax ® | 15 | 10.8 | f |
| — | — | Selectmax ® | 60 | 10.0 | e |
| — | — | Selectmax ® | 240 | 22.5 | c |
| Clarity ® | 140 | Assure II ® | 15 | 44.2 | e |
| Clarity ® | 280 | Assure II ® | 15 | 82.5 | c |
| Clarity ® | 560 | Assure II ® | 15 | 96.7 | a |
| Clarity ® | 140 | Assure II ® | 60 | 72.5 | bc |
| Clarity ® | 280 | Assure II ® | 60 | 93.2 | ab |
| Clarity ® | 560 | Assure II ® | 60 | 96.2 | a |
| Clarity ® | 140 | Assure II ® | 240 | 80.0 | abc |
| Clarity ® | 280 | Assure II ® | 240 | 90.3 | b |
| Clarity ® | 560 | Assure II ® | 240 | 99.2 | a |
| Clarity ® | 140 | Discover NG ® | 15 | 70.8 | c |
| Clarity ® | 280 | Discover NG ® | 15 | 77.5 | c |
| Clarity ® | 560 | Discover NG ® | 15 | 97.8 | a |
| Clarity ® | 140 | Discover NG ® | 60 | 82.5 | ab |
| Clarity ® | 280 | Discover NG ® | 60 | 97.2 | ab |
| Clarity ® | 560 | Discover NG ® | 60 | 98.3 | a |
| Clarity ® | 140 | Discover NG ® | 240 | 88.8 | a |
| Clarity ® | 280 | Discover NG ® | 240 | 98.3 | a |
| Clarity ® | 560 | Discover NG ® | 240 | 99.3 | a |
| Clarity ® | 140 | Selectmax ® | 15 | 75.0 | bc |
| Clarity ® | 280 | Selectmax ® | 15 | 83.3 | c |
| Clarity ® | 560 | Selectmax ® | 15 | 99.8 | a |
| Clarity ® | 140 | Selectmax ® | 60 | 79.7 | abc |
| Clarity ® | 280 | Selectmax ® | 60 | 91.3 | b |
| Clarity ® | 560 | Selectmax ® | 60 | 96.7 | a |
| Clarity ® | 140 | Selectmax ® | 240 | 80.0 | abc |
| Clarity ® | 280 | Selectmax ® | 240 | 91.8 | ab |
| Clarity ® | 560 | Selectmax ® | 240 | 99.2 | a |

TABLE 10
Wild Poinsettia Control.

| | Rate | | Rate | Wild | |
|---|---|---|---|---|---|
| Auxin | (g/ | ACCase | (g/ | Poinsettia | |
| Herbicide | ae/ha) | Inhibitor | ae/ha) | Control (%) | ANOVA |
| Clarity ® | 140 | — | — | 24.2 | e |
| Clarity ® | 280 | — | — | 41.7 | c |
| Clarity ® | 560 | — | — | 75.0 | c |
| — | — | Assure II ® | 15 | 0.0 | f |
| — | — | Assure II ® | 60 | 0.0 | d |
| — | — | Assure II ® | 240 | 0.0 | d |
| — | — | Discover NG ® | 15 | 0.0 | f |
| — | — | Discover NG ® | 60 | 0.0 | d |
| — | — | Discover NG ® | 240 | 0.0 | d |
| — | — | Selectmax ® | 15 | 0.0 | f |
| — | — | Selectmax ® | 60 | 0.0 | d |
| — | — | Selectmax ® | 240 | 0.0 | d |
| Clarity ® | 140 | Assure II ® | 15 | 29.2 | cde |
| Clarity ® | 280 | Assure II ® | 15 | 45.0 | c |
| Clarity ® | 560 | Assure II ® | 15 | 82.5 | ab |
| Clarity ® | 140 | Assure II ® | 60 | 26.7 | cde |
| Clarity ® | 280 | Assure II ® | 60 | 61.7 | a |
| Clarity ® | 560 | Assure II ® | 60 | 80.0 | abc |
| Clarity ® | 140 | Assure II ® | 240 | 35.0 | bc |
| Clarity ® | 280 | Assure II ® | 240 | 49.2 | bc |
| Clarity ® | 560 | Assure II ® | 240 | 86.7 | a |
| Clarity ® | 140 | Discover NG ® | 15 | 25.8 | de |
| Clarity ® | 280 | Discover NG ® | 15 | 49.2 | bc |
| Clarity ® | 560 | Discover NG ® | 15 | 74.2 | c |
| Clarity ® | 140 | Discover NG ® | 60 | 31.7 | bcde |
| Clarity ® | 280 | Discover NG ® | 60 | 60.0 | ab |
| Clarity ® | 560 | Discover NG ® | 60 | 84.2 | a |
| Clarity ® | 140 | Discover NG ® | 240 | 39.2 | ab |
| Clarity ® | 280 | Discover NG ® | 240 | 65.0 | a |
| Clarity ® | 560 | Discover NG ® | 240 | 86.7 | A |
| Clarity ® | 140 | Selectmax ® | 15 | 25.8 | de |
| Clarity ® | 280 | Selectmax ® | 15 | 58.3 | ab |
| Clarity ® | 560 | Selectmax ® | 15 | 76.7 | bc |
| Clarity ® | 140 | Selectmax ® | 60 | 45.8 | a |
| Clarity ® | 280 | Selectmax ® | 60 | 63.3 | a |
| Clarity ® | 560 | Selectmax ® | 60 | 75.8 | bc |
| Clarity ® | 140 | Selectmax ® | 240 | 34.2 | bcd |
| Clarity ® | 280 | Selectmax ® | 240 | 62.5 | a |
| Clarity ® | 560 | Selectmax ® | 240 | 75.0 | c |

TABLE 11
Wild Mustard Control.

| | | | | | | Wild | |
|---|---|---|---|---|---|---|---|
| | | | | Glyphosate | | Mustard | |
| Auxin | Rate | ACCase | Rate | Herbicide | Rate | Control | |
| Herbicide | (g/ae/ha) | Inhibitor | (g/ae/ha) | Formulation | (g/ae/ha) | (%) | ANOVA |
| Clarity ® | 140 | — | — | | | 69.2 | d |
| Clarity ® | 280 | — | — | | | 98.3 | abc |
| Clarity ® | 560 | — | — | | | 99.2 | a |
| — | — | — | — | Roundup | 280 | 90.8 | abc |
| | | | | PowerMax ® | | | |
| — | — | — | — | Roundup | 560 | 97.5 | abcd |
| | | | | PowerMax ® | | | |
| — | — | — | — | Roundup | 840 | 99.2 | a |
| | | | | PowerMax ® | | | |
| — | — | Assure II ® | 23 | — | — | 11.7 | e |
| — | — | Assure II ® | 46 | — | — | 7.5 | f |
| — | — | Assure II ® | 93 | — | — | 17.5 | b |
| — | — | Fusilade | 53 | — | — | 5.8 | e |
| | | DX ® | | | | | |
| — | — | Fusilade | 105 | — | — | 6.7 | f |
| | | DX ® | | | | | |
| — | — | Fusilade | 210 | — | — | 13.3 | b |
| | | DX ® | | | | | |
| Clarity ® | 140 | — | — | Roundup | 280 | 90.8 | abc |
| | | | | PowerMax ® | | | |
| Clarity ® | 280 | — | — | Roundup | 280 | 95.0 | bcde |
| | | | | PowerMax ® | | | |
| Clarity ® | 560 | — | — | Roundup | 280 | 95.8 | a |
| | | | | PowerMax ® | | | |
| Clarity ® | 140 | — | — | Roundup | 560 | 98.3 | a |
| | | | | PowerMax ® | | | |
| Clarity ® | 280 | — | — | Roundup | 560 | 99.5 | a |
| | | | | PowerMax ® | | | |
| Clarity ® | 560 | — | — | Roundup | 560 | 99.0 | a |
| | | | | PowerMax ® | | | |
| Clarity ® | 140 | — | — | Roundup | 840 | 98.3 | a |
| | | | | PowerMax ® | | | |
| Clarity ® | 280 | — | — | Roundup | 840 | 97.7 | abcd |
| | | | | PowerMax ® | | | |
| Clarity ® | 560 | — | — | Roundup | 840 | 99.5 | a |
| | | | | PowerMax ® | | | |
| Clarity ® | 140 | Assure II ® | 23 | | | 85.8 | bc |
| Clarity ® | 280 | Assure II ® | 23 | | | 92.8 | e |
| Clarity ® | 560 | Assure II ® | 23 | | | 97.5 | a |
| Clarity ® | 140 | Assure II ® | 46 | | | 90.8 | abc |
| Clarity ® | 280 | Assure II ® | 46 | | | 94.2 | de |
| Clarity ® | 560 | Assure II ® | 46 | | | 96.7 | a |
| Clarity ® | 140 | Assure II ® | 93 | | | 97.5 | a |
| Clarity ® | 280 | Assure II ® | 93 | | | 98.7 | ab |
| Clarity ® | 560 | Assure II ® | 93 | | | 99.2 | a |
| Clarity ® | 140 | Fusilade | 53 | | | 84.5 | c |
| | | DX ® | | | | | |
| Clarity ® | 280 | Fusilade | 53 | | | 94.5 | cde |
| | | DX ® | | | | | |
| Clarity ® | 560 | Fusilade | 53 | | | 96.2 | a |
| | | DX ® | | | | | |
| Clarity ® | 140 | Fusilade | 105 | | | 92.5 | abc |
| | | DX ® | | | | | |
| Clarity ® | 280 | Fusilade | 105 | | | 99.2 | a |
| | | DX ® | | | | | |
| Clarity ® | 560 | Fusilade | 105 | | | 98.7 | a |
| | | DX ® | | | | | |
| Clarity ® | 140 | Fusilade | 210 | | | 96.2 | ab |
| | | DX ® | | | | | |
| Clarity ® | 280 | Fusilade | 210 | | | 96.7 | ae |
| | | DX ® | | | | | |
| Clarity ® | 560 | Fusilade | 210 | | | 98.3 | a |
| | | DX ® | | | | | |

FIG. 1 illustrates the treatments of wild mustard weed with quizalofop (Panel A)—Untrt (untreated), 0.25× (23 g/ae/ha), 0.5× (46 g/ae/ha), 1× (93 g/ae/ha) and (Panel B)—the treatment with dicamba (Dic. 0.25×, 140 g/ae/ha) and dicamba 0.25× plus quizalofop at +0.25×, +0.50×, and +1× described in Table 11.

TABLE 12
Glyphosate Resistant Palmer Pigweed Control.

| | | | | Glyphosate | |
|---|---|---|---|---|---|
| | Rate | | Rate | Resistant | |
| Auxin | (g/ | ACCase | (g/ | Palmer | |
| Herbicide | ae/ha) | Inhibitor | ae/ha) | Pigweed (%) | ANOVA |
| Clarity ® | 140 | — | — | 87.5 | b |
| Clarity ® | 280 | — | — | 94.2 | a |
| Clarity ® | 560 | — | — | 94.2 | b |
| — | — | Assure II ® | 46 | 0.0 | c |
| — | — | Assure II ® | 93 | 0.0 | b |
| — | — | Assure II ® | 186 | 0.0 | c |
| — | — | Selectmax ® | 136 | 0.0 | c |
| — | — | Selectmax ® | 272 | 0.0 | b |
| — | — | Selectmax ® | 544 | 0.0 | c |
| Clarity ® | 140 | Assure II ® | 46 | 90.0 | b |
| Clarity ® | 280 | Assure II ® | 46 | 94.2 | a |
| Clarity ® | 560 | Assure II ® | 46 | 97.5 | ab |
| Clarity ® | 140 | Assure II ® | 93 | 98.3 | a |
| Clarity ® | 280 | Assure II ® | 93 | 95.0 | a |
| Clarity ® | 560 | Assure II ® | 93 | 100.0 | a |
| Clarity ® | 140 | Assure II ® | 186 | 97.5 | a |
| Clarity ® | 280 | Assure II ® | 186 | 91.7 | a |
| Clarity ® | 560 | Assure II ® | 186 | 98.3 | ab |
| Clarity ® | 140 | Selectmax ® | 136 | 86.7 | b |
| Clarity ® | 280 | Selectmax ® | 136 | 95.8 | a |
| Clarity ® | 560 | Selectmax ® | 136 | 100.0 | a |
| Clarity ® | 140 | Selectmax ® | 272 | 97.5 | a |
| Clarity ® | 280 | Selectmax ® | 272 | 95.8 | a |
| Clarity ® | 560 | Selectmax ® | 272 | 96.7 | ab |
| Clarity ® | 140 | Selectmax ® | 544 | 89.2 | b |
| Clarity ® | 280 | Selectmax ® | 544 | 95.0 | a |
| Clarity ® | 560 | Selectmax ® | 544 | 100.0 | a |

TABLE 13
Glyphosate Resistance Horseweed Control.

| | Auxin | | | Glyphosate | |
|---|---|---|---|---|---|
| | Herbicide | | ACCase | Resistant | |
| Auxin | Rate | ACCase | Rate | Horseweed | |
| Herbicide | (g/ae/ha) | Inhibitor | (g) | Control (%) | ANOVA |
| Clarity ® | 140 | — | — | 75.0 | bc |
| Clarity ® | 280 | — | — | 90.0 | b |
| Clarity ® | 560 | — | — | 96.7 | a |
| — | — | Assure II ® | 46 | 0.0 | d |
| — | — | Assure II ® | 93 | 0.0 | c |
| — | — | Assure II ® | 186 | 0.0 | c |
| — | — | SelectMax ® | 136 | 0.0 | d |
| — | — | SelectMax ® | 272 | 0.0 | c |
| — | — | SelectMax ® | 560 | 0.0 | c |
| Clarity ® | 140 | Assure II ® | 46 | 60.0 | c |
| Clarity ® | 280 | Assure II ® | 46 | 90.0 | b |
| Clarity ® | 560 | Assure II ® | 46 | 95.8 | a |
| Clarity ® | 140 | Assure II ® | 93 | 75.0 | bc |
| Clarity ® | 280 | Assure II ® | 93 | 96.7 | a |
| Clarity ® | 560 | Assure II ® | 93 | 96.7 | a |
| Clarity ® | 140 | Assure II ® | 186 | 85.8 | ab |
| Clarity ® | 280 | Assure II ® | 186 | 98.3 | a |
| Clarity ® | 560 | Assure II ® | 186 | 98.3 | a |
| Clarity ® | 140 | SelectMax ® | 136 | 78.3 | b |
| Clarity ® | 280 | SelectMax ® | 136 | 89.2 | b |
| Clarity ® | 560 | SelectMax ® | 136 | 91.7 | b |
| Clarity ® | 140 | SelectMax ® | 272 | 86.7 | ab |
| Clarity ® | 280 | SelectMax ® | 272 | 96.7 | a |
| Clarity ® | 560 | SelectMax ® | 272 | 98.3 | a |
| Clarity ® | 140 | SelectMax ® | 560 | 97.5 | a |
| Clarity ® | 280 | SelectMax ® | 560 | 98.3 | a |
| Clarity ® | 560 | SelectMax ® | 560 | 96.7 | a |

TABLE 14
Waterhemp Control.

| | Auxin | | | | |
|---|---|---|---|---|---|
| | Herbicide | | ACCase | Waterhemp | |
| Auxin | Rate | ACCase | Rate | Control | Standard |
| Herbicide | (g/ae/ha) | Inhibitor | (g) | (%) | Error |
| — | — | Assure II ® | 46 | 0.0 | 0 |
| — | — | Assure II ® | 93 | 0.0. | 0 |
| — | — | Assure II ® | 186 | 0.0. | 0 |
| Clarity ® | 70 | — | — | 26.7 | 3.3 |
| Clarity ® | 140 | — | — | 41.7 | 6.0 |
| Clarity ® | 280 | — | — | 61.7 | 8.7 |
| Clarity ® | 70 | Assure II ® | 46 | 38.3 | 7.9 |
| Clarity ® | 140 | Assure II ® | 46 | 58.3 | 3.1 |
| Clarity ® | 280 | Assure II ® | 46 | 73.3 | 9.6 |
| Clarity ® | 70 | Assure II ® | 93 | 32.5 | 4.8 |
| Clarity ® | 140 | Assure II ® | 93 | 56.7 | 10.8 |
| Clarity ® | 280 | Assure II ® | 93 | 70.8 | 6.1 |
| Clarity ® | 70 | Assure II ® | 186 | 40.0 | 3.7 |
| Clarity ® | 140 | Assure II ® | 186 | 53.3 | 6.7 |
| Clarity ® | 280 | Assure II ® | 186 | 76.7 | 6.7 |

### Example 3

### Pre-Plant Soil Application of Herbicidal Compositions on Velvetleaf

Dicamba is often used as a pre-plant herbicide and it would be advantageous to have a composition that provides enhanced dicamba activity as a preplant treatment. Dicamba (Clarity®) was mixed with various ACCase inhibitors that included diclofop, clodinafop, pinoxaden, quizalofop and clethodim. The herbicidal compositions were applied to soil at various rates of Clarity® g/ae/ha as shown in Table 15. The ACCase inhibitors were used in the mixture at 1× rates. Velvetleaf seeds were planted in the treated soil and scored for velvetleaf control. The pre-plant activity of dicamba at 280 and 560 g/ae/ha on velvetleaf was significantly enhanced by the addition of the ACCase inhibitors.

TABLE 15
Preplant Velvetleaf Control

| | Rate | | Rate | Velvetleaf | |
|---|---|---|---|---|---|
| Auxin | (g/ | ACCase | (g/ | Control | |
| Herbicide | ae/ha) | Inhibitor | ae/ha) | (%) | ANOVA |
| Clarity ® | 70 | — | — | 6.7 | a |
| Clarity ® | 140 | — | — | 5.0 | a |
| Clarity ® | 280 | — | — | 10.8 | c |
| Clarity ® | 560 | — | — | 51.7 | b |
| Clarity ® | 70 | Hoegrass ® | 1121 | 0.5 | b |
| Clarity ® | 140 | Hoegrass ® | 1121 | 4.8 | a |
| Clarity ® | 280 | Hoegrass ® | 1121 | 41.7 | ab |
| Clarity ® | 560 | Hoegrass ® | 1121 | 71.7 | ab |
| Clarity ® | 70 | Discover NG ® | 70 | 1.5 | b |
| Clarity ® | 140 | Discover NG ® | 70 | 2.3 | a |
| Clarity ® | 280 | Discover NG ® | 70 | 26.7 | abc |
| Clarity ® | 560 | Discover NG ® | 70 | 78.3 | ab |
| Clarity ® | 70 | Axial XL ® | 60 | 1.0 | b |
| Clarity ® | 140 | Axial XL ® | 60 | 3.2 | a |
| Clarity ® | 280 | Axial XL ® | 60 | 25.0 | bc |
| Clarity ® | 560 | Axial XL ® | 60 | 65.0 | ab |
| Clarity ® | 70 | Assure II ® | 93 | 1.0 | b |
| Clarity ® | 140 | Assure II ® | 93 | 7.5 | a |
| Clarity ® | 280 | Assure II ® | 93 | 35.0 | ab |
| Clarity ® | 560 | Assure II ® | 93 | 86.7 | a |
| Clarity ® | 70 | Selectmax ® | 272 | 1.0 | b |
| Clarity ® | 140 | Selectmax ® | 272 | 12.5 | a |
| Clarity ® | 280 | Selectmax ® | 272 | 48.3 | a |
| Clarity ® | 560 | Selectmax ® | 272 | 92.5 | a |

### Example 4

### Crop Safety on Dicamba Tolerant Soybeans

Transgenic dicamba tolerant (DT) soybean seeds (MON 87708) were planted in 3.5-inch square plastic pots containing Redi-earth™ (Scotts-Sierra Horticultural Products Co., Marysville, Ohio). The plants were treated as described in Example 1 and rated for signs of herbicide injury.

The pots were placed on capillary matting in 35 inch×60 inch fiberglass watering trays for overhead and/or sub-irrigation for the duration of the test period so as to maintain optimum soil moisture for plant growth and were fertilized with Osmocote (14-14-14 slow release; Scotts-Sierra Horticultural Products Co., Marysville, Ohio) at the rate of 100 gm/cu.ft. to sustain plant growth for the duration of greenhouse trials. The plants were grown in greenhouses at 27°/21° C. day/night temperature with relative humidity between 25-75 percent to simulate warm season growing conditions of late spring. A 14 hour minimum photoperiod was provided with supplemental light at about 600 μE as needed. Trials were established in a randomized block design randomized by rate with 4 to 6 replications of each treatment depending on plant quality, availability, and to account for any environmental variability that may have occurred within the confines of each greenhouse. The herbicide injury results are shown in Table 16 and demonstrate that dicamba tolerant soybean plants are tolerant to the enhanced activity provided by the addition of the ACCase inhibitors to the dicamba formulation.

TABLE 16
DT Soybeans

| | Rate | | Rate | Herbicide | |
|---|---|---|---|---|---|
| Auxin | (g/ | ACCase | (g/ | Injury | |
| Herbicide | ae/ha) | Inhibitor | ae/ha) | (%) | ANOVA |
| Clarity ® | 140 | | | 0 | d |
| Clarity ® | 280 | | | 1.7 | bc |
| Clarity ® | 560 | | | 2.5 | C |
| — | — | Assure II ® | 23 | 3.0 | Bc |
| — | — | Assure II ® | 46 | 10.2 | a |
| — | — | Assure II ® | 93 | 16.7 | a |
| — | — | Fusilade ® | 53 | 0.3 | d |
| — | — | Fusilade ® | 105 | 0.7 | c |
| — | — | Fusilade ® | 210 | 1.0 | c |
| — | — | Discover NG ® | 18 | 0.3 | d |
| — | — | Discover NG ® | 35 | 2.3 | bc |
| — | — | Discover NG ® | 70 | 2.2 | c |
| Clarity ® | 140 | Assure II ® | 23 | 1.7 | cd |
| Clarity ® | 280 | Assure II ® | 23 | 1.5 | Bc |
| Clarity ® | 560 | Assure II ® | 23 | 1.5 | c |
| Clarity ® | 140 | Assure II ® | 46 | 3.7 | b |
| Clarity ® | 280 | Assure II ® | 46 | 4.2 | b |
| Clarity ® | 560 | Assure II ® | 46 | 3.0 | c |
| Clarity ® | 140 | Assure II ® | 93 | 8.8 | a |
| Clarity ® | 280 | Assure II ® | 93 | 11.7 | a |
| Clarity ® | 560 | Assure II ® | 93 | 10.0 | b |
| Clarity ® | 140 | Fusilade ® | 53 | 0.3 | d |
| Clarity ® | 280 | Fusilade ® | 53 | 1.0 | c |
| Clarity ® | 560 | Fusilade ® | 53 | 1.3 | c |
| Clarity ® | 140 | Fusilade ® | 105 | 1.3 | cd |
| Clarity ® | 280 | Fusilade ® | 105 | 1.8 | bc |
| Clarity ® | 560 | Fusilade ® | 105 | 1.8 | c |
| Clarity ® | 140 | Fusilade ® | 210 | 1.3 | cd |
| Clarity ® | 280 | Fusilade ® | 210 | 1.7 | bc |
| Clarity ® | 560 | Fusilade ® | 210 | 3.5 | c |
| Clarity ® | 140 | Discover NG ® | 18 | 0.8 | d |
| Clarity ® | 280 | Discover NG ® | 18 | 1.8 | bc |
| Clarity ® | 560 | Discover NG ® | 18 | 1.5 | c |
| Clarity ® | 140 | Discover NG ® | 35 | 1.2 | d |
| Clarity ® | 280 | Discover NG ® | 35 | 1.3 | c |
| Clarity ® | 560 | Discover NG ® | 35 | 1.8 | c |
| Clarity ® | 140 | Discover NG ® | 70 | 1.0 | d |
| Clarity ® | 280 | Discover NG ® | 70 | 2.2 | bc |
| Clarity ® | 560 | Discover NG ® | 70 | 1.8 | c |

### Example 5

### Tank Mix Application of Picolinate Containing Herbicidal Compositions on Sunflower

The Herbicidal Compositions described in Table 17 were applied to common sunflower and scored for weed control according to protocols in Example 1. Each ACCase herbicide tested was tank mixed with Stinger® using a complete 3×3 factorial design (3 rates of Stinger by 3 rates of each ACCase herbicide) and compared for weed efficacy. The results are shown in Table 17.

TABLE 17
Sunflower Control.

| | Rate | | Rate | Sunflower | |
|---|---|---|---|---|---|
| Auxin | (g | ACCase | (g/ | Control | |
| Herbicide | ae/ha) | Inhibitor | ae/ha) | (%) | ANOVA |
| Stinger ® | 140 | — | — | 81.7 | d |
| Stinger ® | 280 | — | — | 98.0 | a |
| Stinger ® | 560 | — | — | 100.0 | a |
| Stinger ® | 140 | Assure II ® | 46 | 100.0 | a |
| Stinger ® | 280 | Assure II ® | 46 | 100.0 | a |
| Stinger ® | 560 | Assure II ® | 46 | 100.0 | a |
| Stinger ® | 140 | Assure II ® | 92 | 100.0 | a |
| Stinger ® | 280 | Assure II ® | 92 | 100.0 | a |
| Stinger ® | 560 | Assure II ® | 92 | 100.0 | a |
| Stinger ® | 140 | Assure II ® | 184 | 95.5 | ab |
| Stinger ® | 280 | Assure II ® | 184 | 100.0 | a |
| Stinger ® | 560 | Assure II ® | 184 | 100.0 | a |
| Stinger ® | 140 | Firepower ® | 52 | 92.2 | bc |
| Stinger ® | 280 | Firepower ® | 52 | 99.2 | a |
| Stinger ® | 560 | Firepower ® | 52 | 100.0 | a |
| Stinger ® | 140 | Firepower ® | 104 | 92.5 | abc |
| Stinger ® | 280 | Firepower ® | 104 | 97.5 | a |
| Stinger ® | 560 | Firepower ® | 104 | 100.0 | a |
| Stinger ® | 140 | Firepower ® | 208 | 95.0 | ab |
| Stinger ® | 280 | Firepower ® | 208 | 100.0 | a |
| Stinger ® | 560 | Firepower ® | 208 | 100.0 | a |
| Stinger ® | 140 | SelectMax ® | 68 | 86.7 | cd |
| Stinger ® | 280 | SelectMax ® | 68 | 99.7 | a |
| Stinger ® | 560 | SelectMax ® | 68 | 100.0 | a |
| Stinger ® | 140 | SelectMax ® | 135 | 91.5 | bc |
| Stinger ® | 280 | SelectMax ® | 135 | 97.8 | a |
| Stinger ® | 560 | SelectMax ® | 135 | 100.0 | a |
| Stinger ® | 140 | SelectMax ® | 280 | 89.2 | bcd |
| Stinger ® | 280 | SelectMax ® | 280 | 98.8 | a |
| Stinger ® | 560 | SelectMax ® | 280 | 100.0 | a |

Tank-mix combinations of Stinger® (140 g) and quizalofop or haloxyfop at all test rates showed a statistically significant improvement in plant injury when compared to clopyralid alone. Tank-mix combinations of clopyralid and clethodim showed statistical differences when clethodim was applied at the middle test rate (135 g).

1. A herbicidal composition comprising an auxin-like herbicide and an adjuvant, wherein the effective use rate of the auxin-like herbicide is reduced relative to the herbicidal composition without the adjuvant.

2. The herbicidal composition of claim 1, wherein the adjuvant is an ACCase inhibitor.

3. The herbicidal composition of claim 1, wherein the adjuvant is an ACCase inhibitor and the auxin-like herbicide is dicamba.

4. The herbicidal composition of claim 1, wherein the adjuvant is present in the composition in an amount sufficient to potentiate auxin-like weed control.

5. The herbicidal composition of claim 2, wherein the ACCase inhibitor is selected from the group consisting of aryloxyphenoxypropionates, cyclohexanediones and phenylpyrazoline.

6. The herbicidal composition of claim 1, wherein the auxin-like herbicide is selected from the group consisting of benzoic acid herbicides, phenoxy herbicides, pyridine carboxylic acid herbicides, pyridine oxy herbicides, pyrimidine carboxy herbicides, quinoline carboxylic acid herbicides, and benzothiazole herbicides.

7. The herbicidal composition of claim 5, wherein the herbicide is dicamba and the effective use rate of dicamba is less than 560 grams acid equivalent per hectare and the ACCase inhibitor is an aryloxyphenoxypropionate selected from the group consisting of clodinafop, cyhalofop, diclofop, fenoxaprop, fluazifop, haloxyfop, propaquizafop and quizalofop.

8. The herbicidal composition of claim 5, wherein the herbicide is dicamba and the effective use rate of dicamba is less than or equal to 280 grams acid equivalent per hectare and the ACCase inhibitor is an aryloxyphenoxypropionate selected from the group consisting of clodinafop, cyhalofop, diclofop, fenoxaprop, fluazifop, haloxyfop, propaquizafop and quizalofop.

9. The herbicidal composition of claim 5, wherein the herbicide is dicamba and the effective use rate of dicamba is less than 560 grams acid equivalent per hectare and the ACCase inhibitor is a cyclohexanedione selected from the group consisting of alloxydim, butroxydim, clethodim, cycloxydim, profoxydim, sethoxydim, tepraloxydim and tralkoxydim.

10. The herbicidal composition of claim 5, wherein the herbicide is dicamba and the effective use rate of dicamba is less than or equal to 280 grams acid equivalent per hectare and the ACCase inhibitor is a cyclohexanedione selected from the group consisting of alloxydim, butroxydim, clethodim, cycloxydim, profoxydim, sethoxydim, tepraloxydim and tralkoxydim.

11. The herbicidal composition of claim 5, wherein the herbicide is dicamba and the effective use rate of dicamba is less than 560 grams acid equivalent per hectare and the ACCase inhibitor is the phenylpyrazoline pinoxaden.

12. The herbicidal composition of claim 1, comprising dicamba and clodinafop, wherein the effective use rate of the auxin-like herbicide corresponds to a use rate of between 15 and 70 grams acid equivalent per hectare of clodinafop.

13. The herbicidal composition of claim 1, comprising dicamba and fenxoprop, wherein the effective use rate of the auxin-like herbicide corresponds to a use rate of between 92 and 276 grams acid equivalent per hectare of fenoxprop.

14. The herbicidal composition of claim 1, comprising dicamba and quizalofop, wherein the effective use rate of the auxin-like herbicide corresponds to a use rate of between 47 and 186 grams acid equivalent per hectare of quizalofop.

15. The herbicidal composition of claim 1, comprising dicamba and haloxyfop, wherein the effective use rate of the auxin-like herbicide corresponds to a use rate of between 140 and 416 grams acid equivalent per hectare of haloxyfop.

16. The herbicidal composition of claim 1, comprising dicamba and clethodim, wherein the effective use rate of the auxin-like herbicide corresponds to a use rate of between 68 and 272 grams acid equivalent per hectare of clethodim.

17. A method for inhibiting a weed growth in a field comprising treating soil in the field with an effective use rate of the herbicidal composition of claim 1.

18. The method of claim 17, wherein the auxin-like herbicide is dicamba.

19. The method of claim 17, wherein the adjuvant is an ACCase inhibitor.

20. The method of claim 19, wherein the effective use rate is less than 560 grams acid equivalent per hectare and the ACCase inhibitor is selected from the group consisting of clodinafop, cyhalofop, diclofop, fenoxaprop, fluazifop, haloxyfop, propaquizafop and quizalofop.

21-39. (canceled)
